(19) United States
(12) Patent Application Publication
(10) Pub. No.: US 2008/0203615 A1
(43) Pub. Date: Aug. 28, 2008

(54) MOLD FOR FORMING GOLF BALL COVERS

(76) Inventor: William Brum, Raynham, MA (US)

Correspondence Address: ACUSHNET COMPANY, 333 BRIDGE STREET, P. O. BOX 965, FAIRHAVEN, MA, 02719, US

(21) Appl. No.: 11/678,787

(22) Filed: Feb. 26, 2007

(51) Int. Cl. B29C 45/14

(52) U.S. Cl. 264/267

(57) ABSTRACT

The present invention is an improved single cavity molding device and method for compression molding polyurethane, polyurea or polyurethane/polyurea hybrid covers over golf ball sub-assemblies. The device utilizes top and bottom mold-halves and is particularly novel in that it does not require the use of bolts to secure the mold-halves. The molding device utilizes a pair mold halves, each having a backing plate and mold frame for housing a hemispherical cavity mold. The invention utilizes a plurality of clamping pins, each pin having its top portion reciprocally disposed in a recess of the backing plate of the top mold. Double spring Belleville washers are coupled to the top portion of each clamping pin and upon the application of a vertical force, the washers are compressed to place the device in a controlled state of tension and also cause the clamping pins, to move downward into a locking position with slidable retainers to therein maintain a compressive force of at least 384 pounds on the golf ball sub-assembly for the molding process. Upon completion of the molding process, a vertical force is applied to the top of the clamping pins wherein they are moved out of a coupled relationship with the engagement loops, and with a coordinating horizontal biasing, the retainers are moved away from the pins, whereby the mold-halves may be then opened and a covered golf ball removed.

### FIELD OF THE INVENTION

This invention generally relates to the manufacture of golf balls, and more particularly, to a single cavity mold for compression molding polyurethane, polyurea, or polyurea/polyurethane hybrid covers over golf ball sub-assemblies.

### BACKGROUND OF THE INVENTION

The present invention relates to an improvement to molds, such as that disclosed in U.S. Pat. Nos. 6,936,205, 7,135,138, 7,041,007, 7,041,245, 6,644,948, and 6,439,873, all of which are assigned to the Acushnet Company and are incorporated herein by reference. A typical multi-cavity mold used for applying a thermosetting cover material is disclosed in U.S. Pat. No. 6,439,873 issued to Marshall.

The covers of today's golf balls are made from a variety of materials, but predominately they are either of a thermoplastic material such as SURLYN® and IOTEK® or a thermoplastic material such as polyurethane. In the past, premium golf balls were covered by a balata material. Balata is a natural or synthetic trans-polyisoprene rubber. Balata covered balls were favored by more highly skilled golfers because the softness of the cover allows the player to achieve spin rates sufficient to more precisely control ball direction and distance, particularly on shorter shots. Balata-covered balls, however, are easily damaged, and thus lack the durability required by the average golfer. Accordingly, alternative cover compositions have been developed in an attempt to provide balls with spin rates and a feel approaching those of balata-covered balls, while also providing higher durability and overall distance.

Ionomer resins have, to a large extent, replaced balata as a cover material. Chemically, ionomer resins are a copolymer of an olefin and an α,β-ethylenically-unsaturated carboxylic acid having 10 to 90 percent of the carboxylic acid groups neutralized by a metal ion, as disclosed in U.S. Pat. No. 3,264,272. Commercially available ionomer resins include, for example, copolymers of ethylene and methacrylic or acrylic acid, neutralized with metal salts. Examples of commercially available ionomer resins include, but are not limited to, SURLYN from DuPont de Nemours and Company, and ESCOR®. and IOTEK® from Exxon Corporation. These ionomer resins are distinguished by the type of metal ion, the amount of acid, and the degree of neutralization. However, while ionomer-covered golf balls possess virtually cut-proof covers, the spin and feel are inferior compared to balata-covered balls.

Polyurethanes have also been recognized as useful materials for golf ball covers since about 1960. The resulting golf balls are durable and, unlike ionomer-covered golf balls, polyurethane golf ball covers can be formulated to possess the soft “feel” of balata-covered golf balls. U.S. Pat. No. 4,123,061 teaches a golf ball made from a polyurethane prepolymer formed of polyether with diisocyanate that is cured with either a polyol or an amine-type curing agent. U.S. Pat. No. 5,334,673 discloses the use of two categories of polyurethane available on the market, i.e., thermoset and thermoplastic polyurethanes, for forming golf ball covers and, in particular, thermoset polyurethane-covered golf balls made from a composition of polyurethane prepolymer and a slow-reacting amine curing agent, and/or a difunctional glycol.

Polyureas have also been proposed as cover materials for golf balls. For instance, U.S. Pat. No. 5,484,870 discloses a polyurea composition comprising the reaction product of an organic diisocyanate and an organic amine, each having at least two functional groups. Once these two ingredients are combined, the polyurea is formed, and thus the ability to vary the physical properties of the composition is limited.

Conventionally, golf balls are made by molding a cover around a core. The core may be wound or solid. A wound core typically comprises elastic thread wound about a solid or liquid center. Solid cores typically comprise a single solid piece center or a solid center covered by one or more mantle or boundary layers of material. Wound cores may also include one or more mantle layers.

The cover may be injection molded, compression molded, or cast over the core. Injection molding typically requires a mold having at least one pair of mold cavities; e.g., a first mold cavity and a second mold cavity, which mate to form a spherical recess. In addition, a mold may include more than one mold cavity pair.

In one exemplary injection molding process, each mold cavity may also include retractable positioning pins to hold the core in the spherical center of the mold cavity pair. Once the core is positioned in the first mold cavity, the respective second mold cavity is mated to the first to close the mold. A cover material is then injected into the closed mold. The positioning pins are retracted while the cover material is flowable to allow the material to fill in any holes caused by the pins. When the material is at least partially cured, the covered core is removed from the mold (demolded).

Compression molds also typically include multiple pairs of mold cavities, each pair comprising first and second mold cavities that mate to form a spherical recess. In one exemplary compression molding process, a cover material is pre-formed into half-shells, which are placed, respectively, into each of a pair of compression mold cavities. The core is placed between the cover material half-shells and the mold is closed. The core and cover combination is then exposed to heat and pressure, which cause the cover half-shells to combine and form a full cover.

Casting is the most common method of producing a urethane or urea layer on a golf ball. Casting processes also typically utilize pairs of mold cavities. In a casting process, a cover material is introduced into a first mold cavity of each pair. A core is then either placed directly into the cover material or is held in position (e.g., by an overhanging vacuum or suction apparatus) to contact the cover material in what will be the spherical center of the mold cavity pair. Once the cover material is at least partially cured (e.g., to a point where the core will not substantially move), the cover material is introduced into a second mold cavity of each pair, and the mold is closed. The closed mold is then subjected to heat and pressure to cure the cover material thereby forming a cover on the core. The mold cavities typically include a negative dimple pattern to impart dimples on the cover during the molding process.

Presently, urethane covered golf balls are formed by compression molding in multiple cavity molds. Some of the problems that exist in multi-cavity molds are inherent in the inability to heat or cool each cavity uniformly. This is primarily caused by the uneven contact the fluid makes as it travel through the mold frame. The first cavity in a series is often heated or cooled at a different rate than the last cavity in a series. Also, in multi-cavity molds, some of the cavities wear out prior to others creating inconsistent product quality in the production line.

Currently, the closure of the mold is accomplished by vertical pistons, torque clutch/motor assembly, and assembly of belts, pulleys, and torque bits. Typical cavity molds have multiple bolts to fasten the mold halves together. The process is reversed during the disassembly process. Significant torque variation is present due to the nature of dry assembly and mechanical wear. These assembly/disassembly machinery modules are a root cause of parting line thickness variation and a major source of surface contamination on the golf ball. Golf ball surface contamination accounts for a significant defect generation. The wear and tear of mold bolts, assembly, and disassembly are the major contributor.

It would be a significant improvement of the prior art to have a mold of only a single cavity type design and one that eliminates the need for bolts. In addition to greatly increasing the consistency of heating and cooling of the mold, the single cavity would allow for a more consistent shot size and eliminate the constant monitoring of flow. In present molds, the bolts typically wear at different rates and cause a parting line thickness variation due to bolt force degradation. The elimination of bolts may be accomplished by incorporating the use of compression springs and/or materials with spring like memory.

### SUMMARY

The present invention provides for a single cavity molding device wherein upon placement of a golf ball sub-assembly into the cavity mold and then a urethane or urea cover material cast into the cavity mold, a cover is formed herein by compression molding. The molding device utilizes a pair mold halves, each having a backing plate and mold frame and they each house a hemispherical cavity mold. An object of the invention is to provide for compression molding using only a single cavity and without the need of bolts to secure the mold halves together. The invention utilizes a plurality of clamping pins, each pin having its top portion reciprocally disposed in a recess of the backing plate of the top mold. Double spring Belleville washers are integral to the top portion of each clamping pin and when an outside force is applied, the washers are compressed placing the device into a controlled state of tension. To maintain the compressive force for the duration of the molding cycle, the clamping pins, which have cutout sections in the lower area, are locked in the tension state by a pair of sliding retainers that are positioned in channels of the lower backing plate. Each retainer comprises a pair of engagement loops of a size and shape for locking with the cutout sections of the pins. When an outside source provides a horizontal force to the retainers, the engagement loops of the retainers slide freely within the channel and into contact with the cutout sections of the clamping pins which have been lowered into position by the vertical force upon them, wherein the clamping pins are locked in a tensioned state for the duration of the molding cycle. To release the mold-halves, a subsequent vertical force is applied to the top of the clamping pins wherein they are moved out of the locking relationship with the engagement loops, and with a coordinating horizontal force applied, the retainers are moved away from the pins, releasing the compressive force on the mold-halves.

The present invention provides for a molding device that eliminates the use of bolts to clamp the mold halves during the process, and the subsequent uneven force applied throughout the mold. The uneven application of force is a main cause of uneven thickness of cover material, especially in the application of polyurethane material.

Another object of the invention is the molding of urethane, or polyurea covers.

The molding device of the present invention provides for alignment pins, a diamond shaped pin and a round pin, to allow for quick connection and disconnection of the mold-halves.

The present invention provides a method for molding a cover on a golf ball sub-assembly, wherein all procedures involving wrenches and the like are removed from the process. The material to form the cover is placed into the mold cavity as is the golf sub-assembly (core or core with at least one layer). The mold halves are combined without any mechanical tools. A force is then applied to the device causing Belleville washers on the top portion of the clamping pins to compress the device to provide for the compression necessary along with the application of heat to form the golf ball. Upon completion of the molding of the cover on the ball, the device is cooled and the compressive force released, wherein the device may be opened to remove the golf ball. The compressive force is held in place such that a minimum force of 384 lbs is attained and held. Upon the completion of the molding process, the mold is opened by applying a vertical force on the Belleville washers and then a horizontal force to slide the retainers out from the locking position. The mold may be opened and the golf ball released for further processing such as buffing, imprinting etc.

### BRIEF DESCRIPTION OF THE DRAWINGS

FIG. 1 is a front elevational view of the single cavity mold of the present invention.

FIG. 2 is a side elevational view of the single cavity mold thereof.

FIG. 3 is a top plan view of the single cavity mold thereof.

FIG. 4 is a cross-section side view taken along line A-A of FIG. 3.

FIG. 5 is a cross-section front view taken along line B-B of FIG. 3.

FIG. 6 is a plan view of the bottom surface of the upper backing plate of the cavity mold.

FIG. 7 is a cross-section side view taken along line C-C of FIG. 6.

FIG. 8 is bottom plan view of the upper mold frame including the upper cavity mold of the invention.

FIG. 9 is a top plan view of the upper mold frame of the invention.

FIG. 10 is an elevational front view of the upper mold frame including clamping pins and alignment pins.

FIG. 11 is a top plan view of the lower mold frame including the lower cavity mold.

FIG. 12 is a top plan view of the lower backing plate including the two slidable retainers.

FIG. 13 is a front elevation view of the lower backing plate of the invention.

FIG. 14 is a pictorial top view of one of the retainers.

FIG. 15 is a symmetrical front elevational view of a clamping pin.

FIG. 16 is a symmetrical front view of the round alignment pin.

FIG. 17a is a front elevational view of the diamond shaped alignment pin.

FIG. 17b is a side elevational view of the diamond shaped alignment pin.

FIG. 17c is a bottom plan view of the diamond shaped alignment pin.

### DETAILED DESCRIPTION OF THE INVENTION

There are conventional multi-cavity mold frames such as referenced by U.S. Pat. No. 6,439,873, which are used for casting a layer for a golf ball. Typically, these type molds are used to cast polyurethane covers on a golf ball sub-assembly (not shown). The Acushnet Company (assignee of this application) has for many years used multi-cavity molds that provide four cavities in a mold frame. A significant problem of these compression molds is the inability to achieve equally distributed positive clamping force on the golf balls being formed. The closure of these type molds is accomplished by using vertical pistons, torque clutch/motor assembly, and an assembly of belts, pulleys and torque bits. Each four cavity mold has four bolts to fasten the mold halves together. The constant bolting and unbolting to open and close the mold halves causes an uneven wear and tear of the bolts creating a significant variation in torque between the bolts, resulting in a major source of contamination as well as variation of cover thickness and parting line fluctuations.

The present invention has adopted a unique single cavity precision assembly whereby bolts are eliminated and the product deficiencies and/or maintenance problems caused by premature bolt wear are curbed. This concept physically reduces the assembly/disassembly mechanism relating to vertical clamp, horizontal push cylinders, and bolts. A significant benefit from eliminating bolts, is the removal golf ball surface contamination and thickness variation, which is a by-product resulting from thread wear of the bolts.

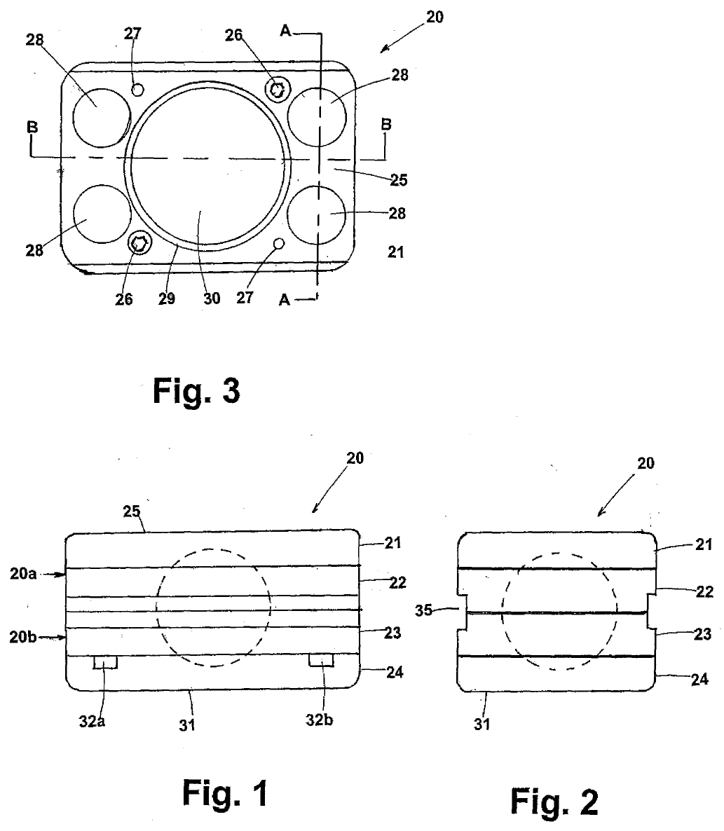

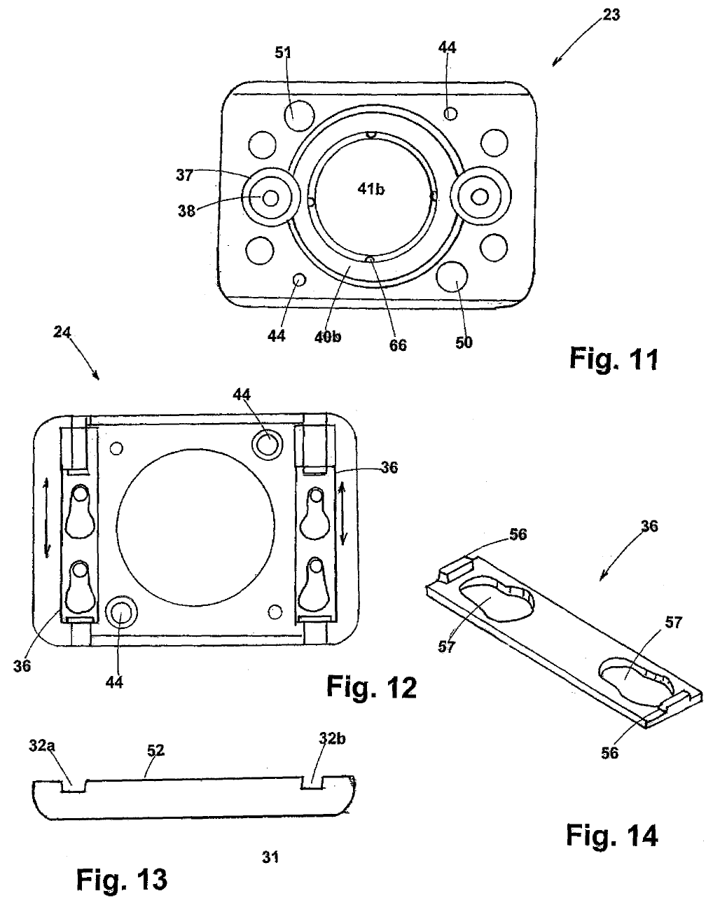

As shown in FIGS. 1-3, the device 20 is comprised of top and bottom mold halves, 20a and 20b. The top half-mold 20a comprises an upper backing plate 21 and an upper mold frame 22, while the bottom half-mold 20b is comprised of a lower backing plate 24 and a lower mold frame 23. The top and bottom surfaces 25, 31, of the device 20 have openings 68 whereby hex screws 26 (⅝ inch) are inserted to fasten the backing plates 21, 24 to the respective mold frames 22, 23. This is shown in FIG. 3 for the top surface 25, while the same arrangement is mirrored on the bottom surface 31 (although not shown). Dowels 27 are disposed in openings 44 to provide proper alignment between the plates 21, 24 and frames 22, 23 respectively. A central opening 29 is defined throughout the central region of the device 20, and this opening is of significant size to provide for housing removable upper and lower cavity molds 39a and 39b. The outer surfaces 30 of these cavity molds 39a and 39b are visible from outside the device 20 through the central opening 29. As best seen in FIGS. 5, 8 and 11, the upper and lower hemispherical cavity molds 39a, 39b, are held in place by a pair of washers 37, wherein a portion of each washer 37 is a positioned over one of the upper or lower cavity flange surfaces 40a and 40b. The flange surfaces 40a, 40b, have a plurality of vents 66 for the overflow of material out of the cavities 41a, 41b. These washers 37 are secured by conventional ⅜ inch screws 38, which are countersunk into orifices 69. The quick removal of the cavity molds 39a, 39b, whether for maintenance or to change a ball dimple pattern, is accomplished by merely removing the screws 38. Upper and lower hemispherical cavities 41a and 41b are defined within the cavity molds 39a, 39b, respectively, and the inner surfaces of these cavity molds 39a, 39b, are populated by a reversed dimple pattern (not shown).

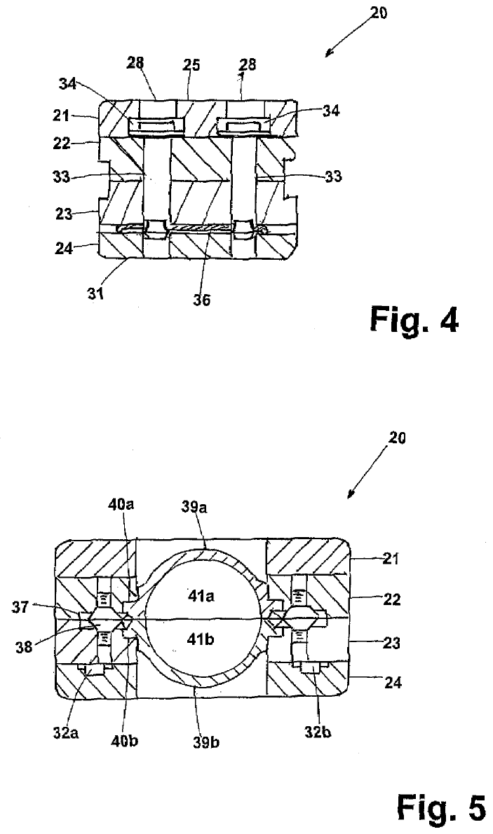

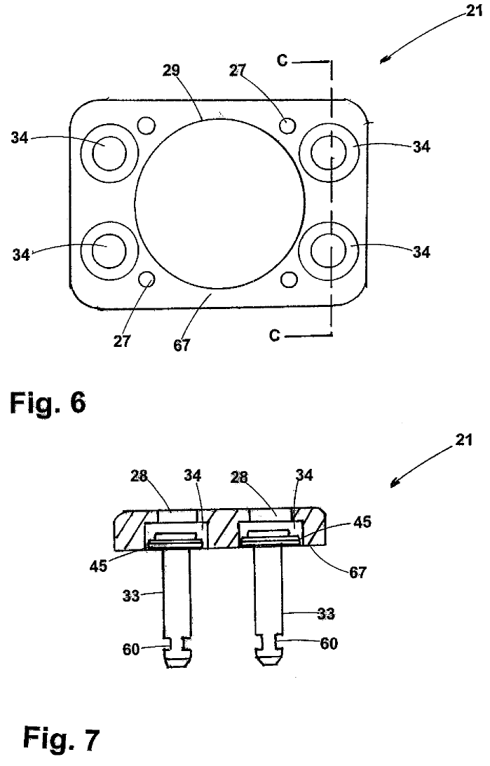

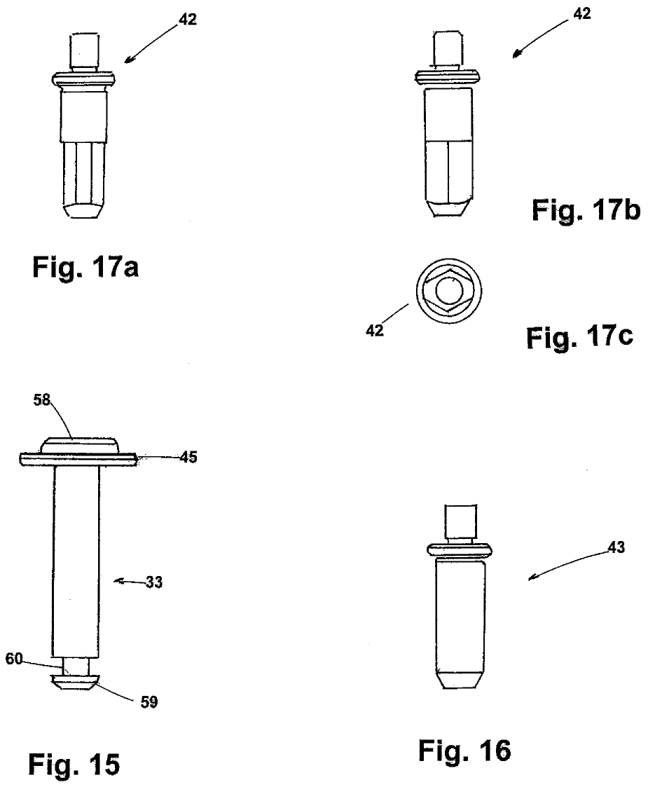

Four cylindrical openings 28 are provided on the top surface 25 of the upper backing plate 21 through which a vertical compressive force is applied to the device 20 (by an source not shown). Cross-sectional views of the device 20 are provided on FIGS. 4 and 5. FIGS. 4, 6 and 7, show recesses 34 that are defined in the bottom surface 67 of the upper backing plate 21, each of a size and shape to accommodate the top section 58 of a clamping pin 33, which includes integral double Belleville washer springs 45 located at a top portion 58 of the pin 33. The clamping pin 33 and springs 45 are detailed in FIG. 15. Upon application of the outside vertical force, a reciprocal movement of the clamping pins 33 biases the Belleville washer springs 45 into applying at least 384 pounds compressive force upon the golf ball sub assembly (not shown) disposed in the upper and lower hemispherical cavities 41a and 41b. This force is held for the duration of the molding process by a locking means discussed below.

In addition to the double Belleville washer springs 45, each clamping pin 33 includes a cutout sections 60 located at the bottom portion 59 of the pin 33. The cutout sections 60 are instrumental for the locking mechanism of the device 20. The locking of the device 20 requires a pair of sliding retainers 36, as shown in FIGS. 12 and 14, disposed in channels 32a, and 32b that are defined on the upper surface 52 of the lower backing plate 24, as best seen in FIGS. 1 and 13. Each retainer 36 has a pair of engagement loops 57, the loops 57 of a size and shape to enable them to slide in and out of frictional locking contact with the cutout sections 60 of the clamping pins 33. Upon a vertical compressive force applied to the top portion of the clamping pins 33, the Belleville washer springs 45 are caused to be placed into tension. Each clamping pin 33 is pushed downward by the vertical force such that the cutout section 60 of each pin is moved into a locking path within one of the channels 32a or 32b. A horizontal force (not shown) is applied to the retainers 36 causing them to slide within the channels 32a or 32b, and subsequently each engagement loop 57 of the retainer 36 biasly slides into a locking position with one of the cutout sections 60. This creates a complete locking of mold halves 20a and 20b without the need of bolts or tools, and the compressive force on the golf ball sub-assembly is held for the duration of the molding process, which includes compression, heating and cooling. Each retainer 36 has a pair of raised ridges 56 that control extent of the movement within the channel 32a or 32b. Upon completion of the molding process, a vertical force is applied to the clamping pins 33 to remove them out of the locking position while a horizontal force slides the retainers 36 such that the engagement loops 57 are disconnected from the locked position with the cutout sections 60. The mold device 20 is then opened and the golf ball released for further finishing, if necessary.

Since the device does not utilize bolts to position and connect the mold halves 20a and 20b and wherein the vertical and horizontal forces are robotically applied, the precision assembly concept of the present invention is easily adaptable to be processed by a high speed assembly line. An engagement groove 35 is shown in FIGS. 1 and 2 where the device 20 is robotically gripped for transport or maneuvering. This is atypical of the batch process method presently being used in the golf ball industry.

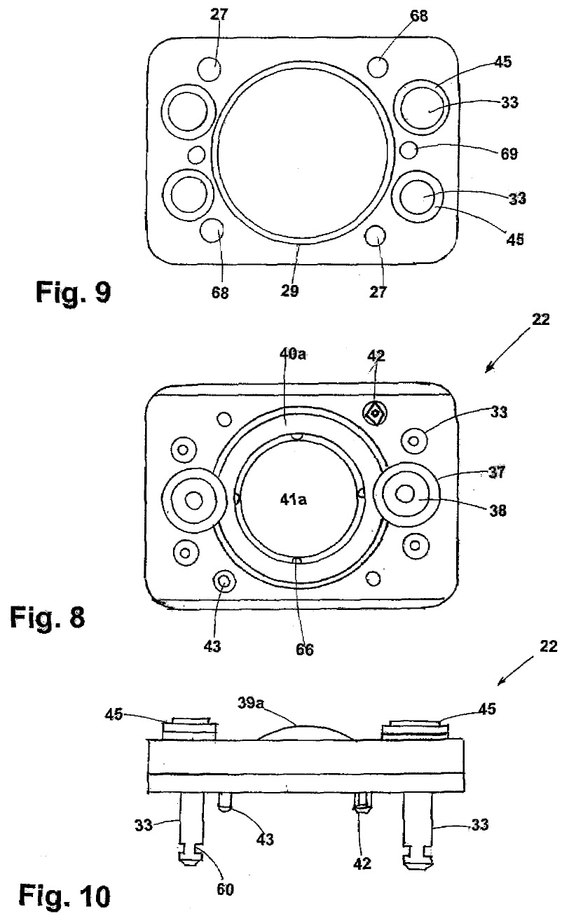

To aid in the high speed quick connecting of the mold halves 20a and 20b, a diamond shaped alignment pin 42 and a round alignment pin 43 are used as shown in FIGS. 8-10. The lower mold frame 23 has receptacles 50 and 51 for receiving the diamond 42 and round 43 alignment pins respectively. While, it is to be appreciated that other shaped alignment pins may be used, these pins 42 and 43 are utilized for this embodiment of the invention. FIG. 16 is a detail of the round alignment pin 43, while FIGS. 17a, 17b, and 17c detail the diamond shaped pin 42.

It will be understood that the claims are intended to cover all changes and modifications of the preferred embodiments of the invention, herein chosen for the purpose of illustration, which do not constitute a departure from the spirit and scope of the invention.

What is claimed is:

1. A single cavity molding device for forming a cover on a golf ball sub-assembly, the device comprising:
a bottom mold-half and a top mold-half;
each mold-half having means for removably housing a hemispherical cavity mold;
a plurality of clamping pins disposed in the top mold-half, each pin having double Belleville washers spring located near the top portion of the pin and a cutout section at a position near the bottom portion;
a pair of channels defined in the bottom mold-half; and
a pair of sliding retainers, each positioned within one of the channels, each retainer having defined therein two engagement loops, each engagement loop of a shape and size to lock with the cutout section of one of the clamping pins,
wherein, upon the application of a vertical force to the top portion of each clamping pin, each pin is biased downward such that its cutout section is moved into a coupling position with one of the engagement loops and the Belleville washer springs create a state of compressed tension, while a horizontal force slides the retainers such that each engagement loop is caused to interlock with one of the cutout sections of the clamping pins, therein locking the hemispherical cavity molds in a compressed state.

2. The molding device according to claim 1, wherein the top mold-half comprises an upper mold frame integrally connected to a bottom surface of an upper backing plate and a lower backing plate having an upper surface and a lower mold frame integrally connected to the upper surface of the lower backing plate.

3. The molding device according to claim 3, wherein the housing means of the hemispherical cavity molds comprises a central opening defined through the device, the opening of a size to accept the hemispherical cavity molds, and each hemispherical cavity mold having a flange surface near to the ball parting line, wherein a section of a pair of washers are a positioned over a section of each flange surface, the washers removably fastened therein by screws.

4. The molding device according to claim 3, wherein each hemispherical mold cavity comprises an inner cavity having an inverted dimple pattern on an inside surface and a plurality of vents recessed in the flange surface.

5. The molding device according to claim 1, wherein a plurality of recesses are defined in the bottom surface of the upper backing plate, the recesses of a size to accommodate the top portions of the clamping pins and the double Belleville washer springs such that each clamping pin upon the application of the vertical force has the opportunity for reciprocal movement within the corresponding recess.

6. The molding device according to claim 2, wherein the channels are defined in the upper surface of the lower backing plate.

7. The molding device according to claim 1, wherein alignment pins extend downward from the bottom surface of the upper backing plate and friction fit to receptacles in the top surface of the lower mold frame, therein allowing for a quick connect and disconnect of the mold-halves without the necessity of bolts.

8. The molding device according to claim 9, wherein at least one of the alignment pins has a multi-faceted cross-sectional shape.

9. The molding device according to claim 1, wherein the plurality of recesses and clamping pins are four.

10. The molding device according to claim 1, wherein the device is for molding polyurethane covers over a golf ball sub-assembly.

11. The molding device according to claim 1, wherein the device is for molding polyurea covers over a golf ball sub-assembly.

12. The molding device according to claim 1, wherein the clamping force applied is a minimum of 384 pounds.

13. A method for molding a cover onto a golf ball sub-assembly, comprising:
providing a single cavity molding device comprising a positional top and bottom mold-halves, each mold-half includes a hemispherical cavity mold with an inverted dimpled inner surface, a plurality of clamping pins having cutout sections at a bottom section and double Belleville washer springs at a top section, and a pair of sliding retainers, each having a pair of engagement loops for friction fitting into a locking position with a pair of clamping pin cutout sections;
providing the golf ball sub-assembly into the hemispherical cavity mold of the bottom mold-half;
providing a cover material into the hemispherical cavities of the top and bottom mold-halves;
connecting the mold-halves by friction fitting without the use of bolts;
applying a vertical force upon a top portion of the clamping pins therein causing the double Belleville washer springs to be placed into a compressed tension and to cause the clamping pins to move downward into a coupling position with the retainers;
applying a horizontal force to cause sliding of the retainers within the channels wherein the engagement loops slide into a locked position with the cutout sections of the clamping pins;
maintaining a minimum force of 384 pounds on the golf ball sub-assembly;
heating the device;
cooling the device;
applying a vertical force on the top portion of the clamping pins to release the lock between the engagement loops and the cutout sections;
applying a horizontal force to the retainers cause the engagement loops to disengage with the clamping pins, therein releasing the force upon the hemispherical cavities;
opening the molding device; and
removing a covered golf ball.

14. The method according to claim 13, wherein the material for forming the cover is a polyurethane.

15. The method according to claim 13, wherein the material for forming the cover is a polyurea.

16. The method according to claim 13, wherein the plurality of clamping pins are four.
